(19) United States
(12) Patent Application Publication
(10) Pub. No.: US 2011/0141145 A1
(43) Pub. Date: Jun. 16, 2011

(54) ELECTRONIC DEVICE AND METHOD CAPABLE OF ZOOMING IMAGES

(75) Inventors: HAI-SEN LIANG, Shenzhen City (CN); TE-JIA LIU, Shenzhen City (CN); HUA-DONG CHENG, Shenzhen City (CN); CHIH-SAN CHIANG, Tu-Cheng (TW); HONG-GANG LI, Shenzhen City (CN); DONG-CHAO YANG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/779,041

(22) Filed: May 12, 2010

(30) Foreign Application Priority Data
Dec. 15, 2009 (CN) 200910311482.1

(51) Int. Cl. G09G 5/00; G06F 3/041

(52) U.S. Cl. 345/661; 345/173

(57) ABSTRACT

An electronic device includes a display screen, a processing unit, and a touch panel. The touch panel includes touch sensitive units, and each touch sensitive unit can be identified by an unique coordinate. The processing unit determines whether first two touch sensitive points are touched at the same time, and further determines whether two more touch sensitive points are also touched at the same time within a preset time interval. The processing unit calculates distance between the first two touched points and then a distance between the second two touched points. The processing unit compares the first distance value with the second distance value, and zooms in or zoom out a displayed image according to the result. A related method is also provided.

### BACKGROUND

1. Technical Field

The present disclosure relates to image zooming technology and, particularly, to an electronic device and a method capable of zooming images.

2. Description of the Related Art

Nowadays, more and more electronic devices employ touch panel as an input device, people can directly slide fingers on the touch panel to execute to zoom in and zoom out an displayed image on the display screen. However, it is easy to damage the touch panel to directly slide fingers on.

Therefore, it is beneficial to provide an electronic device to overcome the limitations described.

### BRIEF DESCRIPTION OF THE DRAWINGS

The components in the drawings are not necessarily drawn to scale, the emphasis instead being placed upon clearly illustrating the principles of an electronic device capable of zooming images and a method thereof. Moreover, in the drawings, like reference numerals designate corresponding parts throughout the several views.

FIG. 1 is a front view of an electronic device capable of zooming images in accordance with an exemplary embodiment.

FIG. 2 is a block diagram of the electronic device of FIG. 1 in accordance with an exemplary embodiment.

FIG. 3 is a flowchart of a method capable of zooming images in accordance with an exemplary embodiment.

### DETAILED DESCRIPTION

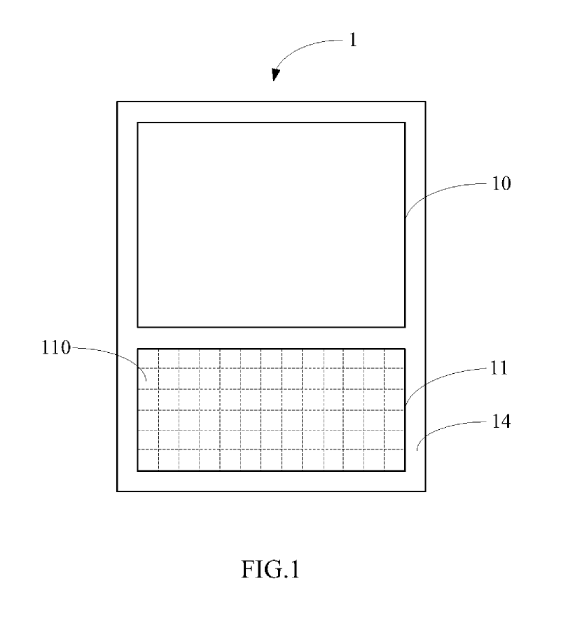

Referring to FIG. 1, an electronic device 1 includes a display screen 10, a touch panel 11, and a signal generating circuit 14. The signal generating circuit 14 is configured for generating signals in response to user touches on the touch panel 11. The touch panel 11 includes a plurality of touch sensitive points 110. Each touch sensitive point 110 corresponds to unique coordinates on the touch panel 11.

In the embodiment, if two touch points 110 are simultaneously touched, the electronic device 1 uses the coordinates of the touched touch points 110 to calculate and store a distance between the two touched touch points 110 as D1. After determining two touch points 110 have been simultaneously touched, the electronic device 1 further determines whether two more touch points 110 are simultaneously touched within a preset time interval. The preset time is employed for preventing accidental touches or touches for other purposes being mistaken for zooming commands. If two more touch points 110 are simultaneously touched within the preset time interval, the electronic device 1 further calculates and stores a distance between the two more touch points 110 as D2. The electronic device 1 then compares D1 with D2 to determine whether to zoom an image displayed on the display screen in or out. In the embodiment, if D1<D2, the electronic device 1 zooms out the displayed image, otherwise, the electronic device 1 zooms in the displayed image. Put simply, if a user wants to zoom in on an image, they should touch the touch panel 11 a first time in two places at the same time, then touch the touch panel 11 again immediately after on two places further apart or vice versa to zoom out. Obviously in other embodiments other responses to touches on the touch panel 11 could be employed with the device 1. It should be noted that in the embodiment if two more touch points 110 are not simultaneously touched within the preset time interval after an initial two touch points 110 are touched, the electronic device 1 erases the distance value D1. If two more touch points 110 are simultaneously touched within the preset time interval, the electronic device 1 erases both the distance values D1 and D2 after executing the zooming function.

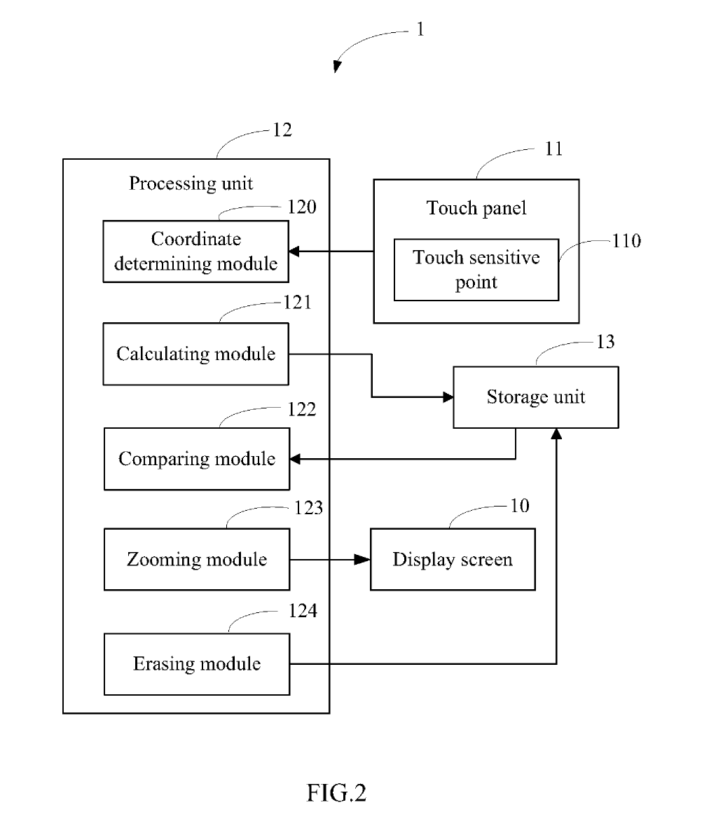

Referring also to FIG. 2, the electronic device 1 further includes a processing unit 12, and a storage unit 13. The processing unit 12 includes a touch determining module 120, a calculating module 121, a comparing module 122, a zooming module 123, and an erasing module 124.

The touch determining module 120 is configured to determine whether two touch points 110 are simultaneously touched. In the embodiment, if the touch determining module 120 determines two coordinates of two touch points 110 are simultaneously received, the touch determining module 120 determines that the two touch points 110 are simultaneously touched. After determining two touch points have been simultaneously touched, the touch determining module 120 further determines whether two more touch points 110 are simultaneously touched within the preset time interval.

The calculating module 121 is configured to calculate the distance between any two touch points 110 being simultaneously touched according to their coordinates, and store the calculated distance in the storage unit 13.

The comparing module 122 is configured to compare the distance D1 with the distance value D2, and generate a comparison result.

The zooming module 123 is configured to zoom in and zoom out the displayed image according to the comparison result of D1 and D2. If the comparing module 122 determines the distance value D1<D2, the zooming module 123 zooms out the displayed image. Otherwise, the zooming module 123 zooms in the displayed image.

The erasing module 124 is configured to erase the distance values stored in the storage unit 13. In the embodiment, if the distance value D1 is stored in the storage unit 13, and the touch determining module 120 determines there are not two more touch points 110 being simultaneously touched within the preset time interval, the erasing module 124 erases the distance value D1. If the touch determining module 120 determines two more touch points 110 are simultaneously touched within the preset time interval, the erasing module 124 waits until after executing the zooming function then erases D1 and D2.

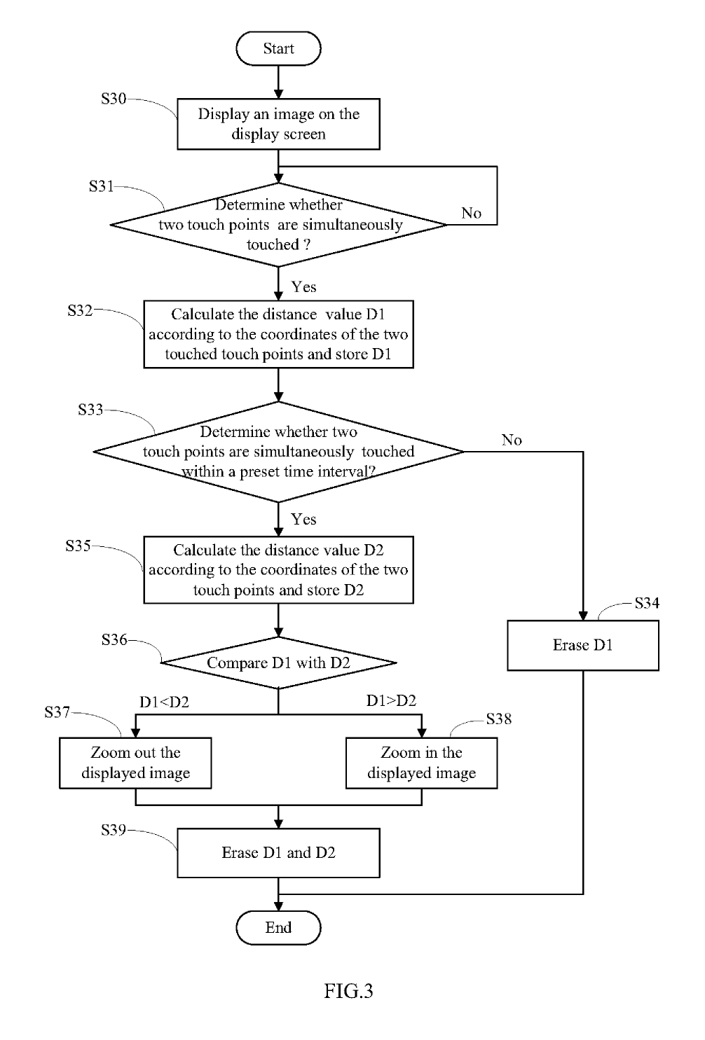

Referring to FIG. 3, a flowchart of a method capable of zooming images in accordance with an exemplary embodiment is shown.

In step S30, the electronic device 1 displays an image on the display screen 10.

In step S31, the touch determining module 120 determines whether two touch points 110 are simultaneously touched. If the touch determining module 120 determines two touch points are simultaneously touched, the procedure goes to step S32, otherwise, the procedure returns to step S31.

In step S32, the calculating module 121 calculates the distance value D1 between the two touched touch points 110 according to their coordinates, and stores D1 in the storage unit 13.

In step 33, the touch determining module 120 further determines whether two more touch points 110 are also simultaneously touched within a preset time interval. If the touch determining module 120 determines two more touch points 110 are simultaneously touched within the preset time interval, the procedure goes to step S35, otherwise, the procedure goes to step S34.

In step 34, the erasing module 124 erases D1 from the storage unit 13.

In step 35, the calculating module 121 calculates the distance value D2 between the two more touched touch points 110 according to their coordinates, and stores D2 in the storage unit 13.

In step 36, the comparing module 122 compares D1 with D2. If D1<D2, the procedure goes to step S37, otherwise, the procedure goes to S38.

In step 37, the zooming module 123 zooms out the displayed image.

In step 38, the zooming module 123 zooms in the displayed image.

In step 39, the erasing module 124 erases D1 and D2 from the storage unit 13.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
a display screen;
a touch panel comprises a plurality of touch sensitive points, each touch sensitive points corresponds to unique coordinates on the touch panel;
a signal generating circuit configured for generating signals in response to user touches on the touch panel;
a processing unit comprising:
a touch determining module configured for determining whether two touch sensitive points are simultaneously touched, and further configured for determining whether two more touch sensitive points are simultaneously touched within a preset time interval after determining two touch sensitive points have been simultaneously touched;
a calculating module configured for calculating a first distance between two touch sensitive points being simultaneously touched according to their coordinates, and further configured for calculating a second distance between two more touch sensitive points being simultaneously touched according to their coordinates within the preset time interval;
a comparing module configured for comparing the first distance value and the second distance value, and generating a comparison result;
a zooming module configured for zooming in and zooming out an displayed image on the display screen according to the comparison result generated by the comparing module.

2. The electronic device as recited in claim 1, wherein when the comparing module determines the first distance value is less than the second distance value, the zooming module zooms out the displayed image, and when the comparing module determines the first distance value is greater than the second distance value, the zooming module zooms in the displayed image.

3. The electronic device as recited in claim 1, further comprising a storage wherein when the touch determining module determines there are not two more touch sensitive points being simultaneously touched within the preset time interval, the storage stores the first distance value, and when the touch determining module determines two more touch sensitive points being simultaneously touched within the preset time interval, the storage stores the first distance value and the second distance value.

4. The electronic device as recited in claim 3, wherein the processing unit further comprises an erasing module, when the storage stores the first distance value, the erasing module erases the first distance value once the preset time interval elapses, and when the storage stores the first distance value and the second distance value, the erasing module waits until after executing the zooming function then erases the first distance value and the second distance value.

5. An image zooming method applied in an electronic device, wherein the electronic device comprises a touch panel, and the touch panel comprises a plurality of touch sensitive points beneath, the method comprising:
displaying an image;
determining whether two touch sensitive points are simultaneously touched;
calculating a first distance value between the two touched touch sensitive points according to their coordinates, and storing the first distance value;
determining whether two more touch sensitive points are simultaneously touched within a preset time interval;
calculating a second distance value between the two more touched touch sensitive points according to their coordinates, and storing the second distance value;
comparing the first distance value with the second distance value, and generating a comparison result; and
determining whether to zoom in or zoom out the displayed image according to the comparison result; and
zooming out and in the displayed image according to the comparison result of the first distance value and the second distance value.

6. The method of claim 5, further comprising:
zooming out the displayed image when the first distance value is less than the second distance value;
zooming in the displayed image when the first distance value is larger than the second distance value.

7. The method of claim 5, further comprising:
erasing the first distance value if two touch sensitive points are not simultaneously touched within the preset time interval after the preset time interval elapses.

8. The method of claim 5, further comprising:
erasing the first distance value and the second distance value if two touch sensitive points are simultaneously touched within the preset time interval after zooming in or zooming out the displayed image.
